(19) United States
(12) Patent Application Publication
(10) Pub. No.: US 2006/0164569 A1
(43) Pub. Date: Jul. 27, 2006

(54) Transmissive electrooptical element and glass pane arrangement provided therewith

(75) Inventors: Werner Sobek, Stuttgart (DE); Walter Haase, Holzgerlingen (DE)

Correspondence Address: BACON & THOMAS, PLLC, 625 SLATERS LANE, FOURTH FLOOR, ALEXANDRIA, VA, 22314, US

(73) Assignee: WERNER SOBEK INGENIEURE GMBH & Co,KG, 70597 STUTTGART GERMANY (DE)

(21) Appl. No.: 10/513,797

(22) PCT Filed: May 13, 2003
(86) PCT No.: PCT/EP03/04962

§ 371 Date: Nov. 18, 2004

(30) Foreign Application Priority Data
May 18, 2002 (DE) 102-23-083.8

(51) Int. Cl. G02F 1/1335

(52) U.S. Cl. 349/96

(57) ABSTRACT

The invention relates to a continuously electrically switchable transmissive electrooptical element (10) for a glass pane arrangement (11) for windows, doors, partitions, fabade displays and the like, provided with a liquid crystal layer (30) upon whose both sides a transparent electrode (27, 33) is respectively arranged; also provided with a respective carrier substrate (26, 34). In order to ensure that the light polarizators are protected against external influences and to enable the transmissive electrooptical element (10) to be produced in an economical manner, a respective light polarisation layer (25, 35) is provided inside the element (10) of the liquid crystal layer (30) in an directly or indirectly adjacent position.

The present invention relates to a continuously variably electrically switchable transmissive electrooptical element in accordance with the preamble to claim 1 and to a pane assembly, equipped with such an element, for windows, doors, partitions, facades, and the like, in accordance with the preamble to one of claims 15 through 19.

Continuously variably electrically switchable transmissive optical elements are known in the display field in the form of so-called TN (twisted nematic) cells and STN (supertwisted nematic) cells. In these cells or elements, which employ a liquid crystal layer, the light polarizer layer is disposed on the outside of the respective carrier substrate, or on its own carriers. Cells with polarizers applied to the outside have the disadvantage that in such cells or elements, the polarizers are unprotected against mechanical and physical factors. If light polarizers with their own carrier substrates are employed, this makes the entire switchable unit more expensive. Since the polarizers are vulnerable to mechanical factors and also to UV radiation and moreover represent a significant cost factor, the aforementioned disadvantages are unacceptable.

In pane assemblies that are meant to have variable light transmittance, electrochromic glasses are currently used, among others; the shading they provide is based on the change in color of pigments caused by an electric current. Such electrochromic glasses change color, however, in darkness and therefore lead to a false-color view through them. Moreover, they require considerable time to change the shading they provide. Currently available systems are moreover not infinitely variable in their transmission; instead, they are controllable only in defined switching increments. Because of the requisite charge transport for the switching operation, the conductivity of the transparent electrical electrodes that are also necessary in these elements plays a major role. The temperature dependency of the conductivity can lead to a varying coloration of the element. Usually, however, this is unwanted.

The object of the present invention is to create a continuously variably electrically switchable transmissive electrooptical element in which the light polarizers are protected against external factors and which can be produced more economically. Moreover, a pane assembly for windows, doors, partitions, facades, and the like is to be created which can be produced economically, using a continuously variably electrically switchable transmissive electrooptical element.

For attaining this object, in a continuously variably electrically switchable transmissive electrooptical element of the type defined, the characteristics recited in claim 1 are provided, and for a pane assembly for windows, doors, partitions, facades, and the like that is equipped with this element, the characteristics recited in claim 15 or 16 or 17 or 18 or 19 are provided.

By the provisions according to the invention, a continuously variably electrically switchable transmissive electrooptical element is created in which, along with the reduction in system components, a reduction in costs from a more-compact design is attained. The light polarizers, applied as a coating, are protected against mechanical and physical factors by being disposed on the inside, and the virtually complete absorption of UV light effected by the carrier substrates takes account of the UV sensitivity of the polarizers. The light polarizer layers placed on the inside can be applied by a more-economical method and can be bound more simply into a switchable element. The total costs for a switchable cell are reduced considerably as a result. Because the light-polarizing coating is capable of functioning as an orientation layer for the liquid crystal, applying an additional orientation layer may under some circumstances be dispensed with.

By the use of polarizing glasses as carrier substrates, a simplification in the cell construction can also be attained, which leads to a reduction in cost. These polarizing glasses are entirely insensitive to UV light. Their function is based on the absorption, which differs spectrally and as a function of the direction of oscillation, in the glass that is doped with foreign substances.

Compared to the versions known until now of an electrooptical element based on a TN cell or even on an STN cell, enormous cost advantages are attained as a result of the use, provided according to the present invention, of liquid crystal polarization inside or outside the cell or by the use of glass polarizers. If the liquid crystal polarization layer is additionally used as an orientation layer for the twisted nematic liquid crystal or the supertwisted nematic liquid crystal enclosed in the cell, then an otherwise required orientation layer inside the electrooptical element may optionally also be dispensed with. This likewise reduces the production costs considerably.

When light polarizers based on mixtures of pigments with a liquid crystal property are used, the spectral transmission or spectral absorption can be varied in a targeted way by means of the mixture ratio of the pigments contained. Both uniform absorption, given a suitable mixture of pigments, and a spectrally highly variable absorption over the effective radiation range can thus be established. Currently, lyotropic liquid crystal polarizer suspensions are known, which are applied to carrier substrates by special coating processes. This type of polarizer can be produced economically.

In a corresponding pane assembly, by means of the provisions of the present invention, employing the technology of the display field, it is attained that the pane assembly can be shaded or darkened in an infinitely varied way and can be adjusted variably or in a targeted way in a very short time in terms of its individual shading phases. The light polarizer layers may be disposed in a protected way either inside the continuously variably electrically switchable transmissive electrooptical element or, to suit the physical requirements of construction, they may be disposed respectively on the inside of a pane of glass of the pane assembly or may be used in the form of polarizing panes of glass as carrier substrates or as final glazing.

Advantageous features of the continuously variably electrically switchable transmissive electrooptical element and in this respect of a pane assembly equipped with it will become apparent from the characteristics of one or more of claims 2 through 14.

Further details of the invention can be learned from the ensuing description, in which the invention is described and explained in detail in terms of the exemplary embodiments shown in the drawings. Shown are:

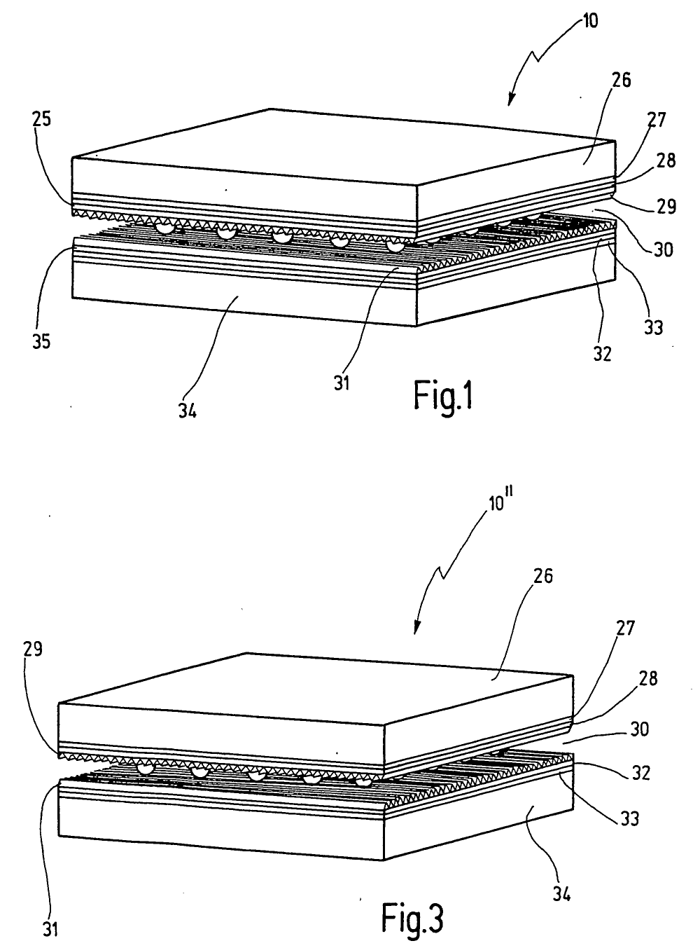

FIG. 1, in a cutaway perspective view, the construction of a continuously variably electrically switchable transmissive electrooptical element, in a first exemplary embodiment of the present invention, for instance in the form of a twisted nematic cell with light polarizer layers located on the inside and with additional orientation layers;

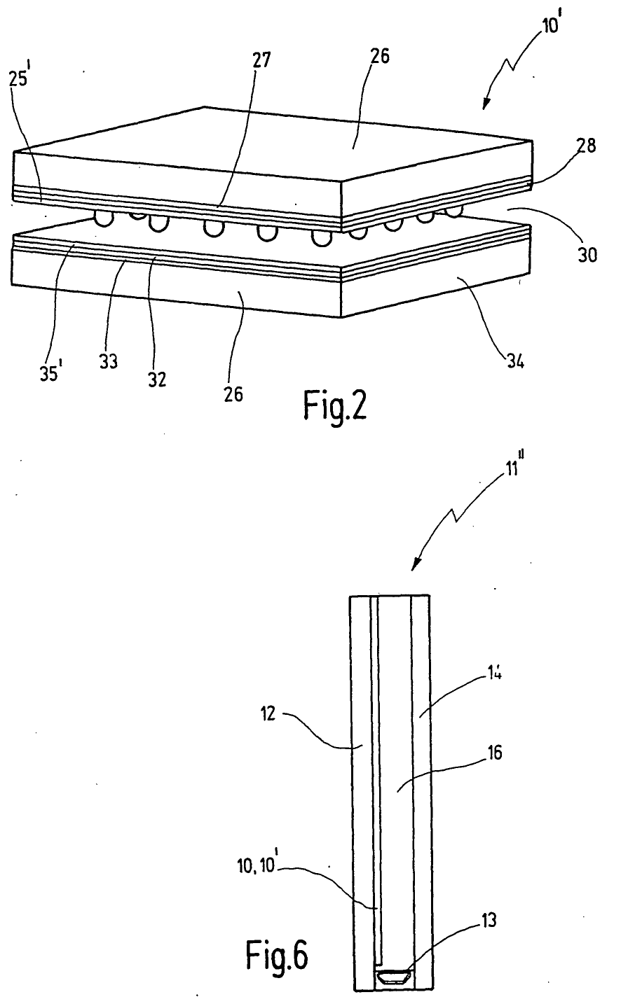

FIG. 2, a view corresponding to FIG. 1 of the electrooptical element, but in a second exemplary embodiment of the present invention, for instance in the form of a twisted nematic cell with light polarizer layers located on the inside, but without additional orientation layers;

FIG. 3, a view corresponding to FIG. 1 of the electrooptical element, but in a third exemplary embodiment of the present invention, for instance in the form of a twisted nematic cell with light polarizer layers located on the inside, but without an internal polarizer but with an orientation layer;

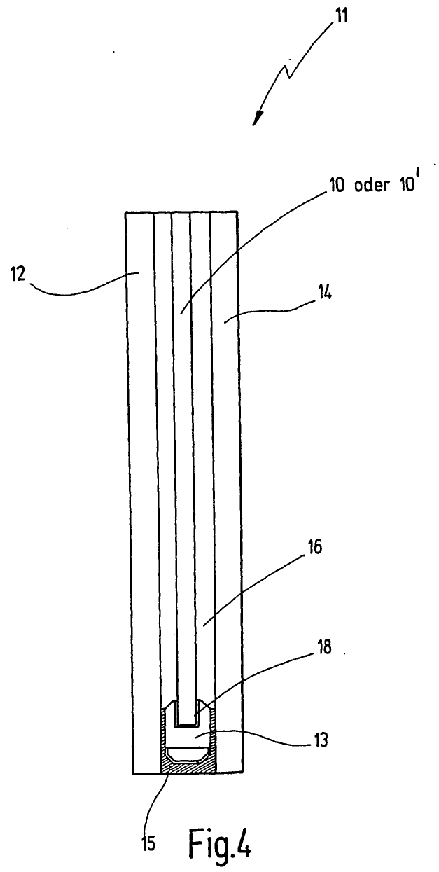

FIG. 4, a pane assembly in the form of insulating glazing for windows, for instance, with a transmissive electrooptical element in accordance with the first or second exemplary embodiment of FIG. 1 or 2, respectively;

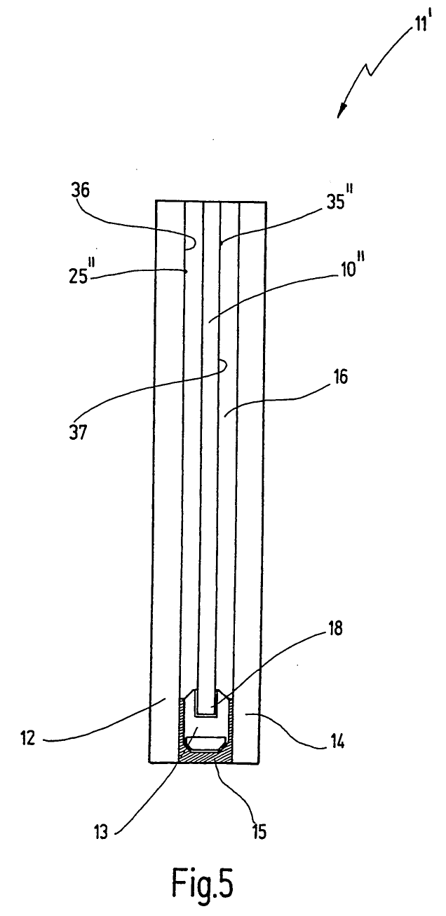

FIG. 5, a view corresponding to FIG. 4 of a pane assembly, but using a transmissive electrooptical element of the third exemplary embodiment of the present invention of FIG. 3; and

FIG. 6, a view of a pane assembly corresponding to FIG. 4, but using a transmissive electrooptical element of a fourth exemplary embodiment of the present invention, in which the outer pane of the pane assembly is at the same time a carrier substrate of the electrooptical element.

The continuously variably electrically switchable transmissive electrooptical element 10 shown in FIG. 1, which is shown in terms of its structural makeup, has a liquid crystal layer 30 in the middle with spacers, not individually shown; the liquid crystal layer is covered on both sides by a respective orientation layer 29 and 31. Located over the orientation layer 29 and 31 is a respective insulator 28 and 32, which is covered by a respective transparent electrode 27 and 33. Remote from the liquid crystal layer 30, on both transparent electrodes 27 and 33, there is a respective carrier substrate 26 and 34, either in the form of a glass carrier or in form of a film carrier. To this extent, the construction of this electrooptical element 10 is approximately the same as for a TN (twisted nematic) cell or STN (supertwisted nematic) cell. In the exemplary embodiment shown, however, a light polarizer layer 25 and 35, respectively, is provided between the respective insulator 28 and 32 and the respective orientation layer 29 and 31. These light polarizer layers 25 and 35 serve to polarize the incident light before it enters the liquid crystal layer 30, in which the light vector is rotated by 90° and 270°, respectively, and can pass through the respective other polarizer 35 and 25 (depending on the side struck by the light). The two light polarizers are rotated relative to one another by a defined angle in terms of their polarization directions, depending on the type of cell. The two transparent electrodes 27 and 33 are triggered via an electrical voltage, and as a result the liquid crystal of the liquid crystal layer 30 is located in an electrical field that varies in its properties. If an electrical field of defined intensity is applied between the two transparent electrodes 27 and 33, the liquid crystal loses its capability of rotating the light vector, so that the light cannot pass through the polarizer 25 or 35 on the output side. In this way, the transmissive electrooptical element 10 can be switched either continuously or infinitely variably and thus shaded. It is understood that depending on the polarization direction of the two polarizers 25 and 35, the disposition may also be reversed; that is, that the transmissive electrooptical element 10 becomes transparent only upon application of an electrical field between the transparent electrodes 25 and 35. The transparent electrodes 25 and 35 are for instance of ITO (indium tin oxide), and the insulator 28, 32 is for instance of SiO₂.

The transmissive electrooptical element 10′ of FIG. 2 is constructed in principle similarly to the transmissive electrooptical element 10 of FIG. 1 and to that extent need not be described again in detail. In this exemplary embodiment, the transmissive electrooptical element 10′ has no independent orientation layer 29 and 31, since the function of that layer is taken on by the respective light polarizer layer 25′ and 35′.

Both the light polarizer layer 25 and 35 (FIG. 1) and the light polarizer layer 25′ and 35′ (FIG. 2) that is provided with the properties of the orientation layer are made insoluble to water and to the liquid crystal filling of the liquid crystal layer 30 by means of a chemical treatment.

An essential feature of the two exemplary embodiments described above is the disposition of the respective light polarizer layer 25, 35 and 25′, 35′ toward the inside of the transmissive electrooptical element 10 and 10′, so that the light polarizer layer that is intrinsically UV-sensitive and sensitive to mechanical factors is protected against external factors.

FIG. 3 shows the usual construction of a twisted nematic cell as a transmissive electrooptical element 10″, with orientation layers 29 and 31 but without an internal polarizer.

FIG. 4 shows one example of the use of the continuously variably electrically switchable transmissive electrooptical element 10 or 10′ of FIGS. 1 and 2 in a pane assembly in the form of an insulating glazing 11 between the outer pane 12 of the pane assembly and its inner pane 14, provided at a spacing from the outer pane by means of a spacer 13. The bond between the outer pane 12, spacer 13 and inner pane 14 is made in the usual diffusion-proof way with the aid of a sealing element 15.

The interior 16 between the outer pane 12 and the inner pane 14 is equipped here symmetrically (or asymmetrically) with the continuously variably electrically switchable transmissive electrooptical element 10 or 10′; the element 10, 10′ has approximately the same two-dimensional extent as the panes 12 and 14, and it is retained for instance in a groove 18 of the spacer 13.

In the exemplary embodiment of an insulating glazing 11′ shown in FIG. 5, a continuously variably electrically switchable transmissive electrooptical element 10″ of FIG. 3 is retained either centrally or eccentrically and differs from the exemplary embodiment of FIG. 4 to the extent that the light polarizer layers 25 and 35, disposed in FIG. 4 inside the element 10, are now disposed as light polarizer layers 25″ and 35″ on the inside 36 of the outer pane 12 and on the inward-oriented outside 37 of the electrooptical element 10, respectively. The light polarizer layers 25″ and 35″ are applied directly to the inside 36 of the outer pane 12 and directly to the inward-oriented outside 37 of the electrooptical element 10″, in the form of a two-dimensional coating or of a film. In this exemplary embodiment, the transmissive electrooptical element 10″ may be embodied with or without insulators 28, 32.

In the exemplary embodiment shown in FIG. 6 of an insulating glazing 11″, one pane of the insulating glazing, for instance the outer pane 12, takes on the task of one carrier substrate. The overall construction of the transmissive electrooptical element 10, 10′ is in principle equivalent to FIG. 1 or FIG. 2, or possibly even FIG. 3.

Although the pane assembly shown in FIGS. 4, 5 and 6 has been described in conjunction with an insulating glazing 11, it is understood that such a pane assembly may also be used independently in a single-pane or multiple-pane assembly, not only for windows but also for doors, interior partitions, external facades, vehicle windows, displays, and the like.

The electrically conductive transparent electrode 27, 33 may be structured such that individual pixels are created which can be configured variably in terms of their size and shape. The individual structural points are provided with suitable color filters and with passive triggering or with an active matrix triggering of the structural elements (pixels).

The liquid crystal layer 30 may comprise a nematic liquid crystal or a cholesterolic liquid crystal or a so-called guest-host liquid crystal or a bistable liquid crystal. Spacers, which assure a defined spacing between the carrier substrates 26, 34, can be located in the liquid crystal layer 30.

Furthermore, the light polarizer layer 25″, 35″ may be embodied in the form of film or polarizing glass or liquid crystal polarizers.

The carrier substrates 26, 34 may be joined together at the edge and tightly enclose the liquid crystal layer 30, the carrier substrate 26, 34 may moreover be embodied as polarizing glass.

1. A continuously variably electrically switchable transmissive electrooptical element (10), in particular for a pane assembly (11) for windows, doors, partitions, facades, displays, and the like, having a liquid crystal layer (30), on both sides of which a respective transparent electrode (27, 33) is disposed, and having one carrier substrate (26, 34) each, characterized in that inside the element (10), indirectly or directly adjacent, preferably on both sides, to the liquid crystal layer (30), a respective light polarizer layer (25, 35) is provided.

2. The element of claim 1, characterized in that the light polarizer layer (25, 35) is made insoluble, by means of a chemical treatment, for water and for a liquid crystal filling.

3. The element of claim 1, characterized in that an orientation layer (29, 31) is disposed immediately adjacent to and on both sides of the liquid crystal layer (30).

4. The element of claim 1, characterized in that the light polarizer layer (25, 35) is provided with orientation properties.

5. The element of claim 1, characterized in that an insulator layer (28, 32) is disposed on the transparent electrodes (27,33), between the liquid crystal layer (30) and the transparent electrodes.

6. The element of claim 1, characterized in that the carrier substrate (26, 34) is a pane of glass or a film.

7. The element of claim 1, characterized in that the light polarizer layer (25″, 35″) is embodied in the form of film or polarizing glass or liquid crystal polarizers.

8. The element of claim 1, characterized in that the carrier substrate (26, 34) is embodied in the form of polarizing glass.

9. The element of claim 1, characterized in that spacers, which assure a defined spacing between the carrier substrates (26, 34), are located in the liquid crystal layer (30).

10. The element of claim 1, characterized in that the carrier substrates (26, 34) are joined together at the edge and tightly enclose the liquid crystal layer (30).

11. The element of claim 4, characterized in that the light polarizer layers are embodied in the form of liquid crystal polarizers.

12. The element of claim 1, characterized in that the liquid crystal layer (30) comprises a nematic liquid crystal or a cholesterolic liquid crystal or a so-called guest-host liquid crystal or a bistable liquid crystal.

13. The element of claim 1, characterized in that the electrically conductive transparent electrode (27, 33) is structured such that individual pixels are created which can be configured variably in terms of their size and shape.

14. The element of claim 13, characterized in that the individual structural points are provided with suitable color filters and with passive triggering or with an active matrix triggering of the structural elements (pixels).

15. A pane assembly (11) for windows, doors, partitions, facades, displays, or the like, characterized in that the pane assembly (11) is assigned a continuously variably electrically switchable transmissive electrooptical element (10) in accordance with claim 1.

16. A pane assembly (11′) for windows, doors, partitions, facades, and the like, having two panes of glass (12, 14), characterized in that between the panes of glass (12, 14), a continuously variably electrically switchable transmissive electrooptical element (10″) in accordance with claim 1 is provided; and that for the transmissive electrooptical element (10), a light polarizer layer (25) is disposed on the pane of glass (12), and a light polarizer layer (35) is disposed on the transmissive electrooptical element (10″).

17. A pane assembly (11″) for windows, doors, partitions, facades, and the like, having two panes of glass (12, 14), characterized in that between the panes of glass (12, 14), a continuously variably electrically switchable transmissive electrooptical element (10 or 10′) in accordance with claim 1 and the outer pane (12) serves as one of the carrier substrates of the electrooptical element (10 or 10′).

18. A pane assembly (11) for windows, doors, partitions, facades, and the like, having two panes of glass (12, 14), characterized in that between the panes of glass (12, 14), a continuously variably electrically switchable transmissive electrooptical element (10) in accordance with to claim 1 is provided; and that the electrically switchable transmissive electrooptical element (10) is retained by means of spacers.

19. A pane assembly (11) for windows, doors, partitions, facades, and the like, having two panes of glass (12, 14), characterized in that one or both panes of glass (12, 14) are provided with a polarizing coating or comprise polarizing glass, and the polarization direction can be selected freely between 0 (parallel disposition) and 90 (perpendicular disposition).
